(19) United States
(12) Patent Application Publication
(10) Pub. No.: US 2026/0337371 A1
(43) Pub. Date: Oct. 29, 2026

(54) CURABLE FLUOROELASTOMER COMPOSITIONS AND LOW-FRICTION CURED FLUOROELASTOMERS (FKM) FORMED THEREFROM

(71) Applicants: THE CHEMOURS COMPANY FC, LLC, WILMINGTON, DE (US); CHEMOURS-MITSUI FLUOROPRODUCTS CO., LTD., TOKYO (JP)

(72) Inventors: CHORONG JEONG, SHIZUOKA (JP); AYAKO YOSHIURA, SHIZUOKA (JP); KENJI TERAUCHI, SHIZUOKA (JP); TAKESHI SATO, SHIZUOKA (JP)

(73) Assignees: THE CHEMOURS COMPANY FC, LLC, WILMINGTON, DE (US); CHEMOURS-MITSUI FLUOROPRODUCTS CO., LTD., TOKYO (JP)

(21) Appl. No.: 19/120,401

(22) PCT Filed: Oct. 11, 2023
(86) PCT No.: PCT/US2023/034944

§ 371 Date: Apr. 11, 2025

Related U.S. Application Data
(60) Provisional application No. 63/415,436, filed on Oct. 12, 2022.

(51) Int. Cl. C08K 3/22; C08J 3/24; C08K 3/04; C08K 3/36; C08K 5/08; C08K 5/136; C08K 5/14; C08K 5/3492; C08K 5/5425; C08K 5/544

(52) U.S. Cl. CPC C08K 3/22; C08J 3/247; C08K 3/04; C08K 3/36; C08K 5/08; C08K 5/136; C08K 5/14; C08K 5/34924; C08K 5/5425; C08K 5/544; C08J 2327/16; C08J 2327/20; C08K 2003/2296; C08K 2201/014; C08K 2201/019

(57) ABSTRACT

A curable fluoroelastomer composition includes a curable fluoroelastomer, a dehydrohalogenating agent, an acid acceptor including bismuth oxide present in the curable fluoroelastomer composition in an amount of at least 3 parts per hundred parts by weight of the curable fluoroelastomer, and at least one silicon-containing chemical present in the curable fluoroelastomer composition in an amount of at least 0.2 parts per hundred parts by weight of the curable fluoroelastomer. A cured fluoroelastomer cured from the curable fluoroelastomer composition has a static coefficient of friction and a dynamic coefficient of friction less than 1.

### CROSS REFERENCE TO RELATED APPLICATIONS

This Application claims the priority benefit of U.S. provisional patent application No. 63/415,436, filed on Oct. 12, 2022, the disclosure of which is hereby incorporated by reference in its entirety.

### FIELD

This disclose relates to compositions and methods for curing fluoroelastomers and cured fluoroelastomers. More specifically, this disclosure relates to curable fluoroelastomer compositions including a curable fluoroelastomer, a dehydrohalogenating agent, an acid acceptor including bismuth oxide, and at least one silicon-containing chemical.

### BACKGROUND

Low-friction fluoroelastomer materials are desirable for many applications.

In an automobile shaft seal, high friction between a fluoroelastomer shaft seal and the rotary shaft causes energy loss in a combustion engine, and low surface friction of the shaft seal has been sought for improving fuel efficiency.

In an electric vehicle system, the high rotation speed of the motor shaft generates excessive frictional heat on the sealing material, and a decrease of the surface friction is considered important to minimize the heat generation and to enable the system design with high motor rotation speed.

The application of a low-friction coating is one approach to reduce friction between surfaces of rubber parts. However, this requires additional processes and costs, and the durability of the coating often becomes a problem.

A better approach to achieve low surface friction is through material composition rather than coating application.

### SUMMARY OF THE INVENTION

Curable fluoroelastomer compositions disclosed herein provide low-friction cured fluoroelastomers. Friction reduction of fluoroelastomers can highly contribute to improved energy efficiency and cost reduction relative to conventional low-friction coating processes.

In one embodiment, a curable fluoroelastomer composition comprises a curable fluoroelastomer, a dehydrohalogenating agent, an acid acceptor comprising bismuth oxide (Bi₂O₃) present in the curable fluoroelastomer composition in an amount of at least 3 parts per hundred parts by weight of the curable fluoroelastomer (phr), and at least one silicon-containing chemical present in the curable fluoroelastomer composition in an amount of at least 0.05 parts per hundred parts by weight of the curable fluoroelastomer.

In one embodiment of the composition, the bismuth oxide is present in the curable fluoroelastomer composition in an amount of 5 to 15 parts per hundred parts by weight of the curable fluoroelastomer.

In another embodiment of the composition, the at least one silicon-containing chemical is present in the curable fluoroelastomer composition in an amount of 0.05 to 5 parts per hundred parts by weight of the curable fluoroelastomer.

In another embodiment of the composition, the at least one silicon-containing chemical is selected from the group consisting of silicon dioxide, calcium silicate (Ca₂SiO₄), calcium metasilicate (CaSiO₃), an organosilicone, γ-aminopropyltriethoxylsilane, vinylethoxysilane, and combinations thereof.

In another embodiment of the composition, the dehydrohalogenating agent is present in the curable fluoroelastomer composition in an amount of at least 1.0 parts per hundred parts by weight of the curable fluoroelastomer.

In another embodiment of the composition, the dehydrohalogenating agent is selected from the group consisting of 2,2 bis(4 hydroxyphenyl)hexafluoropropane, methylhydroquinone, and 2-methylresorcinol.

In another embodiment of the composition, the curable fluoroelastomer comprises a peroxide-curable fluoroelastomer curable by a peroxide cure system and the curable fluoroelastomer composition further comprises a peroxide curative.

In another embodiment of the composition, the curable fluoroelastomer composition contains less than 0.1 parts per hundred parts by weight of the curable fluoroelastomer of magnesium oxide and calcium hydroxide, in combination.

In another embodiment of the composition, the curable fluoroelastomer composition is free or substantially free of magnesium oxide and calcium hydroxide.

In another embodiment of the composition, the curable fluoroelastomer is a dipolymer of hexafluoropropylene and vinylidene fluoride.

In another embodiment, a cured fluoroelastomer cured from a curable fluoroelastomer composition comprises a curable fluoroelastomer, a dehydrohalogenating agent, an acid acceptor comprising bismuth oxide (Bi₂O₃) present in the curable fluoroelastomer composition in an amount of at least 3 parts per hundred parts by weight of the curable fluoroelastomer, and at least one silicon-containing chemical present in the curable fluoroelastomer composition in an amount of at least 0.05 parts per hundred parts by weight of the curable fluoroelastomer.

In one embodiment of the cured fluoroelastomer, the bismuth oxide is present in the curable fluoroelastomer composition in an amount of 5 to 15 parts per hundred parts by weight of the curable fluoroelastomer.

In another embodiment of the cured fluoroelastomer, the at least one silicon-containing chemical is present in the curable fluoroelastomer composition in an amount of 0.05 to 5 parts per hundred parts by weight of the curable fluoroelastomer.

In another embodiment of the cured fluoroelastomer, the at least one silicon-containing chemical is selected from the group consisting of silicon dioxide, calcium metasilicate (CaSiO₃), an organosilicone, γ-aminopropyltriethoxylsilane, vinylethoxysilane, and combinations thereof.

In another embodiment of the cured fluoroelastomer, the dehydrohalogenating agent is present in the curable fluoroelastomer composition in an amount of at least 1.0 parts per hundred parts by weight of the curable fluoroelastomer.

In another embodiment of the cured fluoroelastomer, the dehydrohalogenating agent is selected from the group consisting of 2,2-bis(4-hydroxyphenyl)hexafluoropropane, methylhydroquinone, and 2-methylresorcinol.

In another embodiment of the cured fluoroelastomer, the curable fluoroelastomer comprises a peroxide-curable fluoroelastomer curable by a peroxide cure system and the curable fluoroelastomer composition further comprises a peroxide curative.

In another embodiment of the cured fluoroelastomer, the curable fluoroelastomer composition contains less than 0.1 parts per hundred parts by weight of the curable fluoroelastomer of magnesium oxide and calcium hydroxide, in combination.

In another embodiment of the cured fluoroelastomer, the cured fluoroelastomer is free or substantially free of magnesium oxide and calcium hydroxide.

In another embodiment of the cured fluoroelastomer, the cured fluoroelastomer has a static coefficient of friction of less than 0.5.

In another embodiment of the cured fluoroelastomer, the cured fluoroelastomer has a static coefficient of friction of 0.2 to 0.4.

In another embodiment of the cured fluoroelastomer, the cured fluoroelastomer has a dynamic coefficient of friction of less than 0.5.

In another embodiment of the cured fluoroelastomer, the cured fluoroelastomer has a dynamic coefficient of friction of 0.15 to 0.4.

In another embodiment of the cured fluoroelastomer, the cured fluoroelastomer has a tensile strength of 9.0 to 25 MPa.

In another embodiment of the cured fluoroelastomer, the cured fluoroelastomer has an elongation at break of 150 to 200%.

In yet another embodiment, a method of curing a curable fluoroelastomer comprises forming a curable fluoroelastomer composition and heating the curable fluoroelastomer composition to a cure temperature to cure the curable fluoroelastomer. The curable fluoroelastomer composition comprises the curable fluoroelastomer, a dehydrohalogenating agent, an acid acceptor comprising bismuth oxide (Bi₂O₃) present in the curable fluoroelastomer composition in an amount of at least 3 parts per hundred parts by weight of the curable fluoroelastomer, and at least one silicon-containing chemical present in the curable fluoroelastomer composition in an amount of at least 0.05 parts per hundred parts by weight of the curable fluoroelastomer.

In one embodiment of the method, the heating comprises press curing the curable fluoroelastomer composition and wherein the cure temperature is in the range of about 160 to about 190 °C and the cure time is in the range of about 5 minutes to about 90 minutes.

In another embodiment of the method, the method further comprises post curing the cured fluoroelastomer at a post cure temperature for a post cure time.

In another embodiment of the method, the post cure temperature is in the range of in the range of about 200 to about 260 °C and the post cure time is about 15 minutes or greater.

In another embodiment of the method, the bismuth oxide is present in the curable fluoroelastomer composition in an amount of 5 to 15 parts per hundred parts by weight of the curable fluoroelastomer.

In another embodiment of the method, the at least one silicon-containing chemical is present in the curable fluoroelastomer composition in an amount of 0.05 to 5 parts per hundred parts by weight of the curable fluoroelastomer.

In another embodiment of the method, the at least one silicon-containing chemical is selected from the group consisting of silicon dioxide, calcium silicate (Ca₂SiO₄), calcium metasilicate (CaSiO₃), an organosilicone, γ-aminopropyltriethoxylsilane, vinylethoxysilane, and combinations thereof.

In another embodiment of the method, the dehydrohalogenating agent is present in the curable fluoroelastomer composition in an amount of at least 1.0 parts per hundred parts by weight of the curable fluoroelastomer.

In another embodiment of the method, the dehydrohalogenating agent is selected from the group consisting of 2,2-bis(4-hydroxyphenyl)hexafluoropropane, methylhydroquinone, and 2-methylresorcinol.

In another embodiment of the method, the curable fluoroelastomer comprises a peroxide-curable fluoroelastomer curable by a peroxide cure system and the curable fluoroelastomer composition further comprises a peroxide curative.

In another embodiment of the method, the curable fluoroelastomer composition contains less than 0.1 parts per hundred parts by weight of the curable fluoroelastomer of magnesium oxide and calcium hydroxide, in combination.

In another embodiment of the method, the cured fluoroelastomer is free or substantially free of magnesium oxide and calcium hydroxide.

In another embodiment of the method, the cured fluoroelastomer has a static coefficient of friction of less than 0.5.

In another embodiment of the method, the cured fluoroelastomer has a static coefficient of friction of 0.2 to 0.4.

In another embodiment of the method, the cured fluoroelastomer has a dynamic coefficient of friction of less than 0.5.

In another embodiment of the method, the cured fluoroelastomer has a dynamic coefficient of friction of 0.15 to 0.4.

Other features and advantages of the present invention will be apparent from the following more detailed description of the preferred embodiments, taken in conjunction with the accompanying drawings which illustrate, by way of example, the principles of the invention.

### DETAILED DESCRIPTION

Provided are exemplary curable fluoroelastomer compositions and cured fluoroelastomers including bismuth oxide and at least one silicon-containing chemical.

In exemplary embodiments, the compositions and methods provide low-friction cured fluoroelastomers. In exemplary embodiments, the low-friction cured fluoroelastomers are free or substantially free of strong acid acceptors, which include, but are not limited to, magnesium oxide, calcium oxide, and calcium hydroxide.

As used herein, “silicon-containing chemical” or “Si-containing chemical” refers to any chemical compound including silicon.

As used herein, “low-friction cured fluoroelastomer” refers to a cured fluoroelastomer having a static coefficient of friction of less than 1 and a dynamic coefficient of friction of less than 1. In exemplary embodiments, the low-friction cured fluoroelastomer has a static coefficient of friction of about 0.5 or less and a dynamic coefficient of friction of about 0.5 or less.

As used herein, “substantially free of strong acid acceptors” refers to a curable fluoroelastomer composition or a cured fluoroelastomer formed from a curable fluoroelastomer composition having less than 1 part per hundred parts by weight of the curable fluoroelastomer (phr) of strong acid acceptors. Appropriate amounts of strong acid acceptors in the curable fluoroelastomer composition may include, but are not limited to, less than 1 phr, less than 0.5 phr, less than 0.4 phr, less than 0.3 phr, less than 0.2 phr, less than 0.1 phr, less than 0.05 phr, or any value, range, or subrange therebetween.

In exemplary embodiments, a curable fluoroelastomer composition includes a curable fluoroelastomer, a dehydrohalogenating agent, an acid acceptor including bismuth oxide (Bi₂O₃) present in the curable fluoroelastomer composition in an amount of at least 3 phr, and at least one silicon-containing chemical present in the curable fluoroelastomer composition in an amount of at least 0.05 phr.

Appropriate amounts of bismuth oxide in the curable fluoroelastomer composition may include, but are not limited to, 1.5 phr or greater, 2 phr or greater, 3 phr or greater, 1.5 to 25 phr, 2 to 20 phr, 3 to 18 phr, 5 to 15 phr, or any value, range, or subrange therebetween.

Appropriate amounts of the silicon-containing chemical may include, but are not limited to, at least 0.05 phr, at least 0.1 phr, at least 0.2 phr, 0.05 to 15 phr, 0.1 to 15 phr, 0.2 to 5 phr, or any value, range, or subrange therebetween.

Appropriate silicon-containing chemicals may include, but are not limited to, silicon dioxide; calcium silicate (Ca₂SiO₄); calcium metasilicate (CaSiO₃); an organosilicone; γ-aminopropyltriethoxylsilane; vinylethoxysilane; talc; diatomaceous earth; wollastonite; metal silicates, including, but not limited to, calcium silicate, sodium silicate, borosilicate, lithium disilicate, and/or potassium silicate; water glass; soda-lime glass; borosilicate glass; Z-glass; E-glass; frit glass; silica, including, but not limited to, fumed silica, pyrogenic silica, precipitated silica, and/or silica fume; and/or metallic silicon.

Appropriate amounts of the dehydrohalogenating agent may include, but are not limited to, at least 1.0 phr, 1.0 to 5 phr, at least 1.2 phr, 1.2 to 5 phr, 1.0 to 4 phr, or any value, range, or subrange therebetween.

Appropriate dehydrohalogenating agent may include, but are not limited to, 2,2 bis(4 hydroxyphenyl)hexafluoropropane (BpAF), methylhydroquinone, 2-methylresorcinol, 2,2-bis(4-hydroxyphenyl) propane, 2,2-bis(4-hydroxyphenyl) perfluoropropane, resorcin, 1,3-dihydroxybenzene, 1,7-dihydroxynaphthalene, 2,7-dihydroxynaphthalene, 1,6-dihydroxynaphthalene, 4,4′-dihydroxydiphenyl, 4,4′-dihydroxystilbene, 2,6-dihydroxyanthracene, hydroquinone, catechol, 2,2-bis(4-hydroxyphenyl)) butane, 4,4-bis(4-hydroxyphenyl) valeric acid, 2,2-bis(4-hydroxyphenyl) tetrafluorodichloropropane, 4,4′-dihydroxydiphenyl sulfone, 4,4′-dihydroxydiphenyl ketone, tri (4-hydroxyphenyl) methane, 3,3′,5,5′-tetrachlorobisphenol A, and/or 3,3′,5,5′-tetrabromobisphenol A.

In some embodiments, the curable fluoroelastomer includes a polyhydroxy-curable fluoroelastomer curable by a polyhydroxy curing agent. As used herein, “polyhydroxy-curable” refers to fluoroelastomers that are known to crosslink with polyhydroxy curing agents such as BpAF. Such fluoroelastomers include, but are not limited to, those having a plurality of carbon-carbon double bonds along the main elastomer polymer chain and also fluoroelastomers that contain sites that may be readily dehydrofluorinated. The latter fluoroelastomers include, but are not limited to, those that contain adjacent copolymerized units of vinylidene fluoride (VF2) and hexafluoropropylene (HFP) as well as fluoroelastomers that contain adjacent copolymerized units of VF2 (or tetrafluoroethylene) and a fluorinated comonomer having an acidic hydrogen atom, such as, for example, 2-hydropentafluoropropylene; 1-hydropentafluoropropylene; trifluoroethylene; 2,3,3,3-tetrafluoropropene; or 3,3,3-trifluoropropene. Preferred fluoroelastomers include the copolymers of i) vinylidene fluoride with hexafluoropropylene and, optionally, tetrafluoroethylene (TFE); ii) vinylidene fluoride with a perfluoro(alkyl vinyl ether) such as perfluoro(methyl vinyl ether), 2-hydropentafluoropropylene and optionally, tetrafluoroethylene; iii) tetrafluoroethylene with propylene and 3,3,3-trifluoropropene; iv) tetrafluoroethylene, perfluoro(methyl vinyl ether) and hexafluoro-2-(pentafluorophenoxy)-1-(trifluorovinyloxy)propane, and v) ethylene with tetrafluoroethylene, perfluoro(methyl vinyl ether) and 3,3,3-trifluoropropylene. In some embodiments, the polyhydroxy-curable fluoroelastomer is a dipolymer of hexafluoropropylene and vinylidene fluoride. Polyhydroxy-curable fluoroelastomers may also include iodine-, bromine-, or chlorine-containing elastomers. For example, small amounts (0.01-1 wt %) of chlorine, bromine, or iodine can be introduced with telogens such as, for example, CH₂I₂ or I(CF₂)₄I, or monomers such as, for example, CH₂═CHCF₂CF₂X (X=Br, I) or chlorotrifluoroethylene. In some embodiments, the polyhydroxy-curable fluoroelastomer contains a bis-olefin, such as, for example, CH₂═CH(CF₂)ₙCH═CH₂ (where n=2-8) or CF₂═CFO(CF₂)ₙOCF═CF₂ (where n=2-8).

In some embodiments, the curable fluoroelastomer is a dipolymer of hexafluoropropylene and vinylidene fluoride.

In some embodiments, the curable fluoroelastomer includes a peroxide-curable fluoroelastomer curable by a peroxide cure system and the curable fluoroelastomer composition further includes a peroxide curative.

In some embodiments, the curable composition includes one or more additives. Appropriate additives may include, but are not limited to, fillers, processing aids, accelerators, weak acid acceptors, peroxides, and/or colorants.

The filler may one or more inorganic fillers, one or more polymeric fillers, or combinations thereof. Appropriate inorganic fillers may include, but are not limited to, a medium thermal carbon black, silica, talc, titanium dioxide (TiO₂), barium sulfate (BaSO₄), and/or calcium carbonate (CaCO₃). Appropriate polymeric fillers may include, but are not limited to, polytetrafluoroethylene (PTFE).

Appropriate amounts of filler may include, but are not limited to, about 10 to about 40 phr, about 20 to about 40 phr, about 25 to about 35 phr, about 30 phr, or any value, range, or sub-range therebetween.

Appropriate amounts of processing aid may include, but are not limited to, about 0.1 to about 2 phr, about 0.2 to about 2 phr, about 0.5 to about 1.5 phr, about 1 phr, or any value, range, or sub-range therebetween.

Appropriate accelerators may include, but are not limited to, tertiary sulfonium salts such as [(C₆H₅)₂S⁺(C₆H₁₃)][Cl]⁻, and [(C₆H₁₃)₂S(C₆H₅)]⁺[CH₃CO₂]⁻ and quaternary ammonium, phosphonium, arsonium, and stibonium salts of the formula R₅R₆R₇R₈Y⁺X⁻, where Y is phosphorous, nitrogen, arsenic, or antimony; R₅, R₆, R₇, and R₈ are individually C₁-C₂₀ alkyl, aryl, aralkyl, alkenyl, and the chlorine, fluorine, bromine, cyano, —OR, and —COOR substituted analogs thereof, with R being C₁-C₂₀ alkyl, aryl, aralkyl, alkenyl, and where X is halide, hydroxide, sulfate, sulfite, carbonate, pentachlorothiophenolate, tetrafluoroborate, hexafluorosilicate, hexafluorophosphate, dimethyl phosphate, and C₁-C₂₀ alkyl, aryl, aralkyl, and alkenyl carboxylates and dicarboxylates. Particularly preferred are benzyltriphenylphosphonium chloride, benzyltriphenylphosphonium bromide, tetrabutylammonium hydrogen sulfate, tetrabutylammonium hydroxide, tetrapropylammonium hydroxide, tetrabutylammonium bromide, tributylallylphosphonium chloride, tributyl-2-methoxypropylphosphonium chloride, 1,8-diazabicyclo[5.4.0]undec-7-ene, and benzyldiphenyl(dimethylamino)phosphonium chloride. Other appropriate curing accelerators include methyltrioctylammonium chloride, methyltributylammonium chloride, tetrapropylammonium chloride, benzyltrioctylphosphonium bromide, benzyltrioctylphosphonium chloride, methyltrioctylphosphonium acetate, tetraoctylphosphonium bromide, methyltriphenylarsonium tetrafluoroborate, tetraphenylstibonium bromide, 4-chlorobenzyltriphenyl phosphonium chloride, 8-benzyl-1,8-diazabicyclo(5.4.0)-7-undecenonium chloride, diphenylmethyltriphenylphosphonium chloride, allyltriphenyl-phosphonium chloride, tetrabutylphosphonium bromide, m-trifluoromethyl-benzyltrioctylphosphonium chloride, and other quaternary compounds disclosed in U.S. Pat. Nos. 5,591,804; 4,912,171; 4,882,390; 4,259,463; 4,250,278 and 3,876,654.

In some embodiments, the curable fluoroelastomer is a peroxide curable fluoroelastomer and the curable fluoroelastomer composition is a peroxide curable fluoroelastomer composition further includes a peroxide curative.

Appropriate peroxide curatives may include, but are not limited to, triallyl isocyanurate (TAlC), 1,1-bis (t-butylperoxy)-3,5,5-trimethylcyclohexane, 2,5-dimethylhexane-2,5-dihydroperoxide, di-t-butyl peroxide, t-butylcumyl peroxide, dicumyl peroxide, α,α-bis (t-butylperoxy)-p-diisopropylbenzene, 2,5-dimethyl-2,5-di (t-butylperoxy) hexane, 2,5-dimethyl-2,5-di (t-butylperoxy)-hexyne-3, benzoyl peroxide, t-butyl peroxybenzene, t-butyl peroxymaleic acid, t-butyl peroxyisopropyl carbonate, and/or t-butyl peroxybenzoate.

Appropriate amounts of peroxide curative in a peroxide curable fluoroelastomer composition may include, but are not limited to, about 3.0 to about 5.0 phr, about 3.2 to about 4.8 phr, about 3.4 to about 4.6 phr, about 3.6 to about 4.4 phr, about 3.8 to about 4.2 phr, about 4 phr, or any value, range, or sub-range therebetween.

Appropriate weak acid acceptors may include, but are not limited to, zinc oxide, lead oxide, and/or hydrotalcite.

Appropriate amounts of weak acid acceptor may include, but are not limited to, about 1 phr or less, about 0.1 to about 1 phr, about 0.2 to about 0.8 phr, about 0.5 phr or less, about 0.2 to about 0.5 phr, or any value, range, or sub-range therebetween.

In some embodiments, the curable fluoroelastomer composition contains less than 1.0 phr, such as, for example, less than 0.1 phr, of magnesium oxide and calcium hydroxide, in combination. In some embodiments, the curable fluoroelastomer composition is free or substantially free of magnesium oxide and calcium hydroxide.

In some embodiments, a cured fluoroelastomer cured from a curable fluoroelastomer composition comprises a curable fluoroelastomer, a dehydrohalogenating agent, an acid acceptor comprising bismuth oxide (Bi₂O₃) present in the curable fluoroelastomer composition in an amount of at least 3 parts per hundred parts by weight of the curable fluoroelastomer, and at least one silicon-containing chemical present in the curable fluoroelastomer composition in an amount of at least 0.05 parts per hundred parts by weight of the curable fluoroelastomer.

In some embodiments, the cured fluoroelastomer has a static coefficient of friction of less than 0.5, such as, for example, 0.2 to 0.4.

In some embodiments, the cured fluoroelastomer has a dynamic coefficient of friction of less than 0.5, such as, for example, 0.15 to 0.4.

In some embodiments, the cured fluoroelastomer has a tensile strength of 9.0 to 25 MPa.

In some embodiments, the cured fluoroelastomer has an elongation at break of 150 to 200%.

In some embodiments, a method of curing a curable fluoroelastomer comprises forming a curable fluoroelastomer composition and heating the curable fluoroelastomer composition to a cure temperature to cure the curable fluoroelastomer. The curable fluoroelastomer composition comprises the curable fluoroelastomer, a dehydrohalogenating agent, an acid acceptor comprising bismuth oxide (Bi₂O₃) present in the curable fluoroelastomer composition in an amount of at least 3 parts per hundred parts by weight of the curable fluoroelastomer, and at least one silicon-containing chemical present in the curable fluoroelastomer composition in an amount of at least 0.05 parts per hundred parts by weight of the curable fluoroelastomer.

In some embodiments, the curable fluoroelastomer composition is cured under conventional curing conditions.

In some embodiments, the heating includes press curing.

Appropriate cure temperatures for the heating may include, but are not limited to, about 160 to about 190 °C, about 165 to about 185 °C, about 170 to about 180 °C, about 170 °C, about 180 °C, or any value, range, or subrange therebetween.

Appropriate cure times for the heating may depend on the cure temperature and may include, but are not limited to, about 5 minutes to about 90 minutes, about 5 minutes to about 60 minutes, about 5 minutes to about 40 minutes, about 10 minutes to about 30 minutes, about 5 minutes to about 20 minutes, or any value, range, or subrange therebetween.

In some embodiments, the method further includes post curing the cured fluoroelastomer at a post cure temperature for a post cure period of time.

Appropriate post cure temperatures may include, but are not limited to, about 200 to about 260 °C, about 210 to about 250 °C, about 220 to about 240 °C, about 225 to about 235 °C, about 230 °C, or any value, range, or subrange therebetween.

Appropriate post cure times may depend on the post cure temperature and may include, but are not limited to, about 15 minutes or greater, about 15 minutes to about 24 hours, about 15 minutes to about 16 hours, about 15 minutes to about 8 hours, about 15 minutes to about 4 hours, about 15 minutes to about 2 hours, about 15 minutes to about 1 hour, or any value, range, or subrange therebetween.

Without wishing to be bound by theory, it is believed that the availability of hydrogen fluoride (HF) leads to generation of a low friction layer on the inventive cured fluoroelastomers by reaction of the HF with the Si-containing chemical to form a low friction layer of orthosilicic acid (Si(OH)₄) at the surface of the cured fluoroelastomer. The cure reaction in a polyhydroxy cure system, such as with BpAF, generates HF, but strong acid acceptors, such as magnesium oxide and calcium hydroxide, capture HF, which prevents its reaction with the Si-containing chemical. It is believed that bismuth oxide as an acid acceptor permits the cure process to proceed while allowing some HF to be available to react with the Si-containing chemical.

It is believed that, in contrast, a purely peroxide cure system does not generate HF to react with the Si-containing chemical to generate a low-friction surface layer, but some BpAF may be included as a dehydrohalogenating agent to generate some HF for formation of a low-friction surface layer in the presence of bismuth oxide and Si-containing chemical (and in some cases in the absence of bismuth oxide).

### TEST METHODS

### Static and Dynamic Coefficients of Friction

Static and dynamic coefficients of friction were measured with a Shimadzu Autograph AGS-5kNX tester. The values were calculated by a force to drag a stainless steel reference material on a test fluoroelastomer cured sheet sample at a rate of 100 mm/min.

### Tensile Strength and Elongation at Break

The tensile strength in MPa and the elongation at break in % were determined on the cured, unaged fluoroelastomers at 23 °C by the ISO 37:2011 testing protocol.

### EXAMPLES

### Comparative Fluoroelastomer Curing Examples

Comparative fluoroelastomer curing compositions included curable fluoroelastomer, 30 parts by weight per 100 parts curable fluoroelastomer (phr) carbon black filler, and dehydrohalogenating agent and acid acceptor in the amounts shown in Tables 1-4. Certain comparative fluoroelastomer curing compositions further included accelerator, Si-containing chemical, and/or processing aid, as indicated in Tables 1-4 in phr.

### Inventive Fluoroelastomer Curing Examples

Inventive fluoroelastomer curing compositions included curable fluoroelastomer, 30 phr carbon black filler, and dehydrohalogenating agent, Bi₂O₃ acid acceptor, and Si-containing chemical in the amounts shown in Tables 1-4, with the exception that Inventive Example 10 included only 5 phr carbon black filler, with some of the listed Si-containing chemical also acting as filler. Certain inventive fluoroelastomer curing compositions further included accelerator, processing aid, and/or additional acid acceptor, as indicated in Tables 1-4 in phr.

### Fluoroelastomer Curing Results and Cured Properties

Fluoroelastomer curing compositions were press cured at a press cure temperature in the range of 170 to 180 °C for a press cure time in the range of 7 to 60 minutes. Cured fluoroelastomers were then post cured at a post cure temperature of 230 °C for a post cure time in the range of 30 minutes to 24 hours, with the exception of Comparative Example 7, which did not cure, and Comparative Example 8, which was not post-cured.

### Effects of Acid Acceptor and Si-Containing Chemical on Friction Properties

Table 1 shows that the presence of bismuth oxide and silicon-containing chemical, in combination, in a curable fluoroelastomer composition produces a low-friction cured fluoroelastomer.

In Inventive Examples 1-8, varying types and amounts of Si-containing chemical in combination with bismuth oxide as the sole acid acceptor produced cured fluoroelastomers with static coefficients in the range of 0.18 to 0.34 and dynamic coefficients of friction in the range of 0.16 to 0.32. The Si-containing chemicals in Inventive Examples 1-8 were: a silicon dioxide (1.1), a sodium salt of silicic acid (1), a silicon dioxide (2), a silicon dioxide (3), a silicon dioxide (4), a silicon dioxide (5), a γ-aminopropyltriethoxysilane (6), a vinyltriethoxysilane (7), a combination of an organosilicone and a silicon dioxide (8), and a wollastonite (9), respectively.

Inventive Example 9 shows that the further inclusion of a small amount of a weak acid acceptor (zinc oxide) does not negatively affect the friction properties of the resulting cured fluoroelastomer.

TABLE 1
Compositions of Varying Acid Acceptor and Si-Containing Chemicals

| | Inventive Examples | | | | | | | | | | Comparative Examples | | | | | |
|---|---|---|---|---|---|---|---|---|---|---|---|---|---|---|---|---|
| Example # | 1.1 | 1 | 2 | 3 | 4 | 5 | 6 | 7 | 8 | 9 | 1 | 1.1 | 2 | 3 | 4 | 5 |
| BpAF | 2.00 | 2.00 | 2.00 | 2.00 | 2.00 | 2.00 | 2.00 | 2.00 | 2.00 | 1.76 | 1.76 | 2.00 | 2.00 | 1.76 | 1.76 | 1.76 |
| accelerator | 0.5 | 0.5 | 0.5 | 0.5 | 0.5 | 0.5 | 0.5 | 0.5 | 0.5 | 0.44 | 0.44 | 0.5 | 0.5 | 0.44 | 0.44 | 0.44 |
| acid acceptor (Bi₂O₃) | 15 | 15 | 15 | 15 | 15 | 15 | 15 | 15 | 15 | 15 | 15 | 15 | | | 15 | 15 |
| acid acceptor (MgO) | | | | | | | | | | | | | 3 | 3 | 1 | |
| acid acceptor (Ca(OH)₂) | | | | | | | | | | | | | 6 | 6 | | 1 |
| acid acceptor (ZnO) | | | | | | | | | | 1 | | | | | | |
| Si-containing chemical | 0.05 | 0.25 | 3 | 3 | 2.79 | 3.65 | 0.98 | 0.97 | 1 | 3.9 | | 0.01 | | 0.25 | 3.9 | 3.9 |
| processing aid | 1 | 1.75 | 1 | 1 | 1 | 1 | 1 | 1 | 1 | 1.75 | | 1 | 1 | 1.75 | 1.75 | 1.75 |
| Static COF | 0.18 | 0.27 | 0.34 | 0.18 | 0.26 | 0.23 | 0.23 | 0.33 | 0.29 | 0.18 | 2.79 | 2.26 | 2.11 | 2.70 | 2.60 | 2.73 |
| Dynamic COF | 0.35 | 0.22 | 0.30 | 0.16 | 0.32 | 0.21 | 0.20 | 0.28 | 0.23 | 0.18 | 1.39 | 1.30 | N/D | 1.76 | 1.95 | 1.31 |

Comparative Example 1 shows that bismuth oxide as an acid acceptor does not provide a low-friction cured fluoroelastomer in the absence of an Si-containing chemical.

Comparative Examples 2 and 3 show that a standard acid acceptor combination of 3 phr magnesium oxide and 6 phr calcium hydroxide, both strong acid acceptors, in place of bismuth oxide do not provide a low-friction cured fluoroelastomer either in the absence or in the presence of an Si-containing chemical.

Finally, Comparative Examples 4 and 5 show that the presence of just 1 phr of magnesium oxide or calcium hydroxide disrupts the ability of the combination of bismuth oxide and Si-containing chemical to provide a low-friction cured fluoroelastomer. Comparative example 1.1 shows that a relatively lower amount (0.01 phr) of Si-containing chemical results in relatively poor friction properties of the resulting cured fluoroelastomer.

### Effects of Dehydrohalogenating Agent and Amount of Bi₂O₃ on Friction Properties

Inventive Example 10 in Table 2 shows that an amount of BpAF dehydrohalogenating agent as low as 1.28 phr was sufficient to produce a low-friction cured fluoroelastomer, whereas the 0.96 phr of BpAF of Comparative Example 6 was insufficient. Compositions including the alternative dehydrohalogenating agents methyl-hydroquinone and 2-methylresorcinol of Inventive Examples 11 and 12, respectively, at 1.12 phr, in place of BpAF were also able to provide low-friction cured fluoroelastomers.

TABLE 2
Compositions of Varying Dehydrohalogenating
Agent and Amount of Bi₂O₃

| | | | | | Comparative | |
|---|---|---|---|---|---|---|
| | Inventive Examples | | | | Examples | |
| Example # | 10 | 11 | 12 | 13 | 6 | 7 |
| BpAF | 1.28 | | | 1.28 | 0.96 | 1.28 |
| methyl-hydroquinone | | 1.12 | | | | |
| 2-methyl-resorcinol | | | 1.12 | | | |
| accelerator | 0.93 | 1.5 | 1.3 | 0.93 | 0.24 | 0.93 |
| acid acceptor (Bi₂O₃) | 15 | 15 | 15 | 5 | 15 | 1 |
| Si-containing chemical | 25.699 | 0.25 | 0.25 | 1.25 | 0.25 | 1.25 |
| processing aid | 1 | 0.75 | 0.75 | 0.84 | 0.75 | 0.84 |
| Static COF | 0.27 | 0.24 | 0.28 | 0.22 | 3.80 | no cure |
| Dynamic COF | 0.29 | 0.21 | 0.25 | 0.25 | 1.27 | no cure |

Inventive Example 13 shows that an amount of Bi₂O₃ as low as 5 phr was sufficient to produce a low-friction cured fluoroelastomer, whereas the 1 phr of bismuth oxide of Comparative Example 7 failed to cure.

### Effects of Post Cure on Friction Properties

Table 3 shows that the composition of Comparative Example 8 without a post cure did not achieve a low-friction cured fluoroelastomer.

TABLE 3
Compositions of Varying Dehydrohalogenating
agent and Amount of Bi₂O₃

| | |
|---|---|
| Comparative | |
| Example | Inventive Examples |

| Example # | 8 | 14 | 15 | 16 |
|---|---|---|---|---|
| BpAF | 1.76 | 1.76 | 1.76 | 1.76 |
| accelerator | 0.44 | 0.44 | 0.44 | 0.44 |
| acid acceptor (Bi₂O₃) | 15 | 15 | 15 | 15 |
| Si-containing chemical | 3.9 | 3.9 | 3.9 | 3.9 |
| processing aid | 1.75 | 1.75 | 1.75 | 1.75 |
| Post cure time (hr) | 0.0 | 0.5 | 8.0 | 24.0 |
| Static COF | 1.97 | 0.26 | 0.35 | 0.38 |
| Dynamic COF | 1.32 | 0.24 | 0.35 | 0.38 |

Inventive Examples 14-16 had the same composition as Comparative Example 8 but were post cured at 230 °C for the amount of time indicated in Table 3. Just 30 minutes of post cure time at 230 °C was sufficient to produce a low-friction cured fluoroelastomer and increasing the post cure time up to 24 hours did not further reduce the coefficients of friction.

### Effects of Curable Fluoroelastomer on Friction Properties

Table 4 shows that compositions of peroxide (PO) curable fluoroelastomer can also be cured to low-friction cured fluoroelastomer by including bismuth oxide and an Si-containing chemical in appropriate amounts in the composition. Inventive Examples 17, 18, and 19 each included a different PO curable fluoroelastomer having 66% F, 68% F, and 64% F, respectively. The compositions of Table 4 also included 1.5 phr of 2,5-dimethyl-2,5-di(t-butylperoxy)hexane and 2.5 phr of triallyl isocyanurate (TAlC) as peroxide curatives.

TABLE 4
Compositions of Peroxide Curable Fluoroelastomer

| | | | | Comparative | |
|---|---|---|---|---|---|
| | Inventive Examples | | | Examples | |
| Example # | 17 | 18 | 19 | 9 | 10 |
| BpAF | 1.76 | 2.00 | 2.00 | | |
| Peroxide curative | 4.0 | 4.0 | 4.0 | 4.0 | 4.0 |
| acid acceptor (Bi₂O₃) | 5 | 15 | 15 | | 15 |
| Si-containing chemical | 0.25 | 0.25 | 0.25 | 0.25 | |
| processing aid | 1.75 | 0.75 | 0.75 | 1.75 | 1 |
| Static COF | 0.48 | 0.30 | 0.20 | 2.81 | 2.01 |
| Dynamic COF | 0.54 | 0.26 | 0.20 | 1.52 | 1.22 |

In contrast, Comparative Example 9 lacked bismuth oxide and Comparative Example 10 lacked an Si-containing chemical, and both compositions did not produce a low-friction cured fluoroelastomer.

Tensile strength and elongation at break were measured for the peroxide curable composition of Table 4 (data not shown). Although the Inventive Examples of Table 4 had advantageous low-friction properties, they also had lower tensile strength and lower elongation at break than the Comparative Examples of Table 4, which was not observed for polyhydroxy-curable fluoroelastomers.

In addition to the different PO curable fluoroelastomers of Table 4, compositions including Bi₂O₃ and Si-containing chemical and containing different BpAF curable fluoroelastomers of varying F content over the range of 66% to 70% were tested and produced low-friction cured fluoroelastomers (data not shown).

All above-mentioned references are hereby incorporated by reference herein.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A curable fluoroelastomer composition comprising:
a curable fluoroelastomer;
a dehydrohalogenating agent;
an acid acceptor comprising bismuth oxide (Bi₂O₃) present in the curable fluoroelastomer composition in an amount of at least 3 parts per hundred parts by weight of the curable fluoroelastomer; and
at least one silicon-containing chemical present in the curable fluoroelastomer composition in an amount of at least 0.05 parts per hundred parts by weight of the curable fluoroelastomer.

2. The curable fluoroelastomer composition of claim 1, wherein the bismuth oxide is present in the curable fluoroelastomer composition in an amount of 5 to 15 parts per hundred parts by weight of the curable fluoroelastomer.

3. The curable fluoroelastomer composition of claim 1, wherein the at least one silicon-containing chemical is present in the curable fluoroelastomer composition in an amount of 0.05 to 5 parts per hundred parts by weight of the curable fluoroelastomer.

4. The curable fluoroelastomer composition of claim 1, wherein the at least one silicon-containing chemical is selected from the group consisting of silicon dioxide, calcium silicate (Ca₂SiO₄), calcium metasilicate (CaSiO₃), an organosilicone, γ-aminopropyltriethoxylsilane, vinylethoxysilane, and combinations thereof.

5. The curable fluoroelastomer composition of claim 1, wherein the dehydrohalogenating agent is present in the curable fluoroelastomer composition in an amount of at least 1.0 parts per hundred parts by weight of the curable fluoroelastomer.

6. The curable fluoroelastomer composition of claim 1, wherein the dehydrohalogenating agent is selected from the group consisting of 2,2-bis(4-hydroxyphenyl)hexafluoropropane, methylhydroquinone, and 2-methylresorcinol.

7. The curable fluoroelastomer composition of claim 1, wherein the curable fluoroelastomer comprises a peroxide-curable fluoroelastomer curable by a peroxide cure system and the curable fluoroelastomer composition further comprises a peroxide curative.

8. The curable fluoroelastomer composition of claim 1, wherein the curable fluoroelastomer composition contains less than 0.1 parts per hundred parts by weight of the curable fluoroelastomer of magnesium oxide and calcium hydroxide, in combination.

9. The curable fluoroelastomer composition of claim 1, wherein the curable fluoroelastomer composition is free or substantially free of magnesium oxide and calcium hydroxide.

10. The curable fluoroelastomer composition of claim 1, wherein the curable fluoroelastomer is a dipolymer of hexafluoropropylene and vinylidene fluoride.

11. A cured fluoroelastomer cured from a curable fluoroelastomer composition comprising:
a curable fluoroelastomer;
a dehydrohalogenating agent;
an acid acceptor comprising bismuth oxide (Bi₂O₃) present in the curable fluoroelastomer composition in an amount of at least 3 parts per hundred parts by weight of the curable fluoroelastomer; and
at least one silicon-containing chemical present in the curable fluoroelastomer composition in an amount of at least 0.05 parts per hundred parts by weight of the curable fluoroelastomer.

12. The cured fluoroelastomer of claim 11, wherein the bismuth oxide is present in the curable fluoroelastomer composition in an amount of 5 to 15 parts per hundred parts by weight of the curable fluoroelastomer.

13. The cured fluoroelastomer of claim 11, wherein the at least one silicon-containing chemical is present in the curable fluoroelastomer composition in an amount of 0.05 to 5 parts per hundred parts by weight of the curable fluoroelastomer.

14. The cured fluoroelastomer of claim 11, wherein the at least one silicon-containing chemical is selected from the group consisting of silicon dioxide, calcium silicate (Ca₂SiO₄), calcium metasilicate (CaSiO₃), an organosilicone, γ-aminopropyltriethoxylsilane, vinylethoxysilane, and combinations thereof.

15. The cured fluoroelastomer of claim 11, wherein the dehydrohalogenating agent is present in the curable fluoroelastomer composition in an amount of at least 1.0 parts per hundred parts by weight of the curable fluoroelastomer.

16. The cured fluoroelastomer of claim 11, wherein the dehydrohalogenating agent is selected from the group consisting of 2,2-bis(4-hydroxyphenyl)hexafluoropropane, methylhydroquinone, and 2-methylresorcinol.

17. The cured fluoroelastomer of claim 11, wherein the curable fluoroelastomer comprises a peroxide-curable fluoroelastomer curable by a peroxide cure system and the cured fluoroelastomer further comprises a peroxide curative.

18. The cured fluoroelastomer of claim 11, wherein the curable fluoroelastomer composition contains less than 0.1 parts per hundred parts by weight of the curable fluoroelastomer of magnesium oxide and calcium hydroxide, in combination.

19. The cured fluoroelastomer of claim 11, wherein the cured fluoroelastomer is free or substantially free of magnesium oxide and calcium hydroxide.

20. The cured fluoroelastomer of claim 11, wherein the cured fluoroelastomer has a static coefficient of friction of less than 0.5.

21. The cured fluoroelastomer of claim 11, wherein the cured fluoroelastomer has a static coefficient of friction of 0.2 to 0.4.

22. The cured fluoroelastomer of claim 11, wherein the cured fluoroelastomer has a dynamic coefficient of friction of less than 0.5.

23. The cured fluoroelastomer of claim 11, wherein the cured fluoroelastomer has a dynamic coefficient of friction of 0.15 to 0.4.

24. The cured fluoroelastomer of claim 11, wherein the cured fluoroelastomer has a tensile strength of 9.0 to 25 MPa.

25. The cured fluoroelastomer of claim 11, wherein the cured fluoroelastomer has an elongation at break of 150 to 200%.

26. A method of curing a curable fluoroelastomer comprising:
forming a curable fluoroelastomer composition comprising the curable fluoroelastomer; a dehydrohalogenating agent; an acid acceptor comprising bismuth oxide (Bi₂O₃) present in the curable fluoroelastomer composition in an amount of at least 3 parts per hundred parts by weight of the curable fluoroelastomer; and at least one silicon-containing chemical present in the curable fluoroelastomer composition in an amount of at least 0.05 parts per hundred parts by weight of the curable fluoroelastomer; and
heating the curable fluoroelastomer composition to a cure temperature for a cure time to cure the curable fluoroelastomer.

27. The method of claim 26, wherein the heating comprises press curing the curable fluoroelastomer composition and wherein the cure temperature is in the range of about 160 to about 190 °C and the cure time is in the range of about 5 minutes to about 90 minutes.

28. The method of claim 26 further comprising post curing the cured fluoroelastomer at a post cure temperature for a post cure time.

29. The method of claim 28, wherein the post cure temperature is in the range of in the range of about 200 to about 260 °C and the post cure time is about 15 minutes or greater.

30. The method of claim 26, wherein the bismuth oxide is present in the curable fluoroelastomer composition in an amount of 5 to 15 parts per hundred parts by weight of the curable fluoroelastomer.

31. The method of claim 26, wherein the at least one silicon-containing chemical is present in the curable fluoroelastomer composition in an amount of 0.05 to 5 parts per hundred parts by weight of the curable fluoroelastomer.

32. The method of claim 26, wherein the at least one silicon-containing chemical is selected from the group consisting of silicon dioxide, calcium silicate (Ca₂SiO₄), calcium metasilicate (CaSiO₃), an organosilicone, γ-aminopropyltriethoxylsilane, vinylethoxysilane, and combinations thereof.

33. The method of claim 26, wherein the dehydrohalogenating agent is present in the curable fluoroelastomer composition in an amount of at least 1.0 parts per hundred parts by weight of the curable fluoroelastomer.

34. The method of claim 26, wherein the dehydrohalogenating agent is selected from the group consisting of 2,2-bis(4-hydroxyphenyl)hexafluoropropane, methylhydroquinone, 2 and 2-methylresorcinol.

35. The method of claim 26, wherein the curable fluoroelastomer comprises a peroxide-curable fluoroelastomer curable by a peroxide cure system and the curable fluoroelastomer composition further comprises a peroxide curative.

36. The method of claim 26, wherein the curable fluoroelastomer composition contains less than 0.1 parts per hundred parts by weight of the curable fluoroelastomer of magnesium oxide and calcium hydroxide, in combination.

37. The method of claim 26, wherein the cured fluoroelastomer is free or substantially free of magnesium oxide and calcium hydroxide.

38. The method of claim 26, wherein the cured fluoroelastomer has a static coefficient of friction of less than 0.5.

39. The method of claim 26, wherein the cured fluoroelastomer has a static coefficient of friction of 0.2 to 0.4.

40. The method of claim 26, wherein the cured fluoroelastomer has a dynamic coefficient of friction of less than 0.5.

41. The method of claim 26, wherein the cured fluoroelastomer has a dynamic coefficient of friction of 0.15 to 0.4.
